(19) United States
(12) Patent Application Publication
(10) Pub. No.: US 2006/0166181 A1
(43) Pub. Date: Jul. 27, 2006

(54) Computer peripheral device wireless linking method and system

(75) Inventors: Yen-Po Tai, Taipei (TW); Tsung-Hsien Yang, Taipei (TW)

Correspondence Address: BIRCH STEWART KOLASCH & BIRCH, PO BOX 747, FALLS CHURCH, VA, 22040-0747, US

(73) Assignee: INVENTEC MULTIMEDIA & TELECOM CORPORATION

(21) Appl. No.: 11/337,474

(22) Filed: Jan. 24, 2006

(30) Foreign Application Priority Data
Jan. 27, 2005 (TW) 094102430

(51) Int. Cl. G09B 3/00

(52) U.S. Cl. 434/350

(57) ABSTRACT

A computer peripheral device wireless linking method and system is proposed, which is designed for use in conjunction with a wireless peripheral device and a computer platform for the wireless peripheral device to be linkable via an access-point device to the computer platform; and which is characterized by the use of a wireless LAN searching and linking technology for the wireless peripheral device to be linked via the access-point device to the computer platform without having to use Ethernet ports, input devices, and monitor screens as in the case of prior art. This feature allows the wireless peripheral device to be linked to the computer platform with an instant play capability, such that the use of the wireless peripheral device is more convenient.

### BACKGROUND OF THE INVENTION

1. Field of the Invention

This invention relates to wireless information technology, and more particularly, to a computer peripheral device wireless linking method and system which is designed for use in conjunction with a wireless peripheral device and a computer platform for the purpose of allowing the wireless peripheral device to be linkable to the computer platform via an access-point device.

2. Description of Related Art

A Web cam is a network-based digital imaging device that can be linked to a computer platform, such as a desktop computer, a notebook computer, a network workstation, or the like, and can be used to capture motion or still images and transfer the capture images via a network system, such as Internet or a LAN (Local Area Network) system, to a remote computer platform. This feature allows a user at a remote site to view the images captured by the Web cam. Web cams are widely utilized in video conferencing, video chat, security monitoring, online broadcast, to name just a few.

Traditionally, a Web cam is linked to a computer platform via wired means, such as the standard USB (Universal Serial Bus) interface. With the advances in the technology of wireless networking, newly developed Web cams can now be linked to a computer platform via wireless means.

One drawback to the present wireless Web cams, however, is that the users need to manually install the Web cam's driver program into the computer platform through the use of Ethernet ports, input devices (i.e., keyboard and mouse), and monitor screens. For this sake, the present Web cams are incapable of offering the user with an instant play capability.

### SUMMARY OF THE INVENTION

It is therefore an objective of this invention to provide a method and system for linking a wireless peripheral device to a computer platforms which allows the wireless peripheral device to be wireless linked to the computer platform without having to use Ethernet ports, input devices, and monitor screens as in the case of prior art, and instead can be linked to the computer platform via an access-point device with an instant play capability.

The computer peripheral device wireless linking method according to the invention comprises: (1) on the wireless peripheral device, performing an access-point device searching procedure to search the nearby environment where the wireless peripheral device is located for any access-point devices; and if at least one is found, issuing a link requesting enable message; (2) on the wireless peripheral device, responding to the link requesting enable message by issuing a link requesting message to the access-point device which then transfers the link requesting message to the computer platform; (3) on the computer platform, responding to the link requesting message by issuing a driver loading enable message; (4) on the computer platform, responding to the driver loading enable message by performing a driver loading procedure to load a corresponding driver program related to the wireless peripheral device into the computer platform; and after the driver loading procedure is completed, issuing a ready-for-linking message via the access-point device to the wireless peripheral device; and (5) on the wireless peripheral device, responding to the ready-for-linking message by establishing a wireless link between the wireless peripheral device and the computer platform via the access-point device.

In architecture, the computer peripheral device wireless linking system is based on a distributed architecture comprising: (A) a peripheral-side unit; and (B) a platform-side unit; wherein the peripheral-side unit is installed on the wireless peripheral device and includes: (A1) an access point searching module, (A2) a link requesting module, and (A3) a link establishing module; and the platform-side unit is installed on the computer platform and includes: (B1)a link request responding module, and (B2)a driver loading module; and wherein the access point searching module in the peripheral-side unit is capable of searching the nearby environment where the wireless peripheral device is located for any access-point devices; if at least one is found, capable of issuing a link requesting enable message; the link requesting module in the peripheral-side unit is capable of responding to the link requesting enable message from the access point searching module by issuing a link requesting message to the access-point device; the link request responding module in the platform-side unit is capable of responding to the link requesting message from the link requesting module in the peripheral-side unit by issuing a driver loading enable message; the driver loading module in the platform-side unit is capable of responding to the driver loading enable message from the link request responding module by performing a driver loading procedure to load a corresponding driver program related to the wireless peripheral device into the computer platform; and after the driver loading procedure is completed, capable of issuing a ready-for-linking message via the access-point device to the wireless peripheral device; and the link establishing module in the peripheral-side unit is capable of responding to the ready-for-linking message from the driver loading module in the platform-side unit by establishing a wireless link between the wireless peripheral device and the computer platform via the access-point device.

The computer peripheral device wireless linking method and system according to the invention is characterized by the use of a wireless LAN searching and linking technology for a wireless peripheral device to be linked via a access-point device to a computer platform without having to use Ethernet ports, input devices, and monitor screens as in the case of prior art. This feature allows the wireless peripheral device to be linked to the computer platform with an instant play capability, such that the use of the wireless peripheral device is more convenient.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and distributed architecture of the computer peripheral device wireless linking system according to the invention; and

FIG. 2 is a schematic diagram showing the application of the computer peripheral device wireless linking system of the invention.

### DETAILED DESCRIPTION OF PREFERRED EMBODIMENTS

The computer peripheral device wireless linking method and system according to the invention is disclosed in full details by way of preferred embodiments in the following with reference to the accompanying drawings.

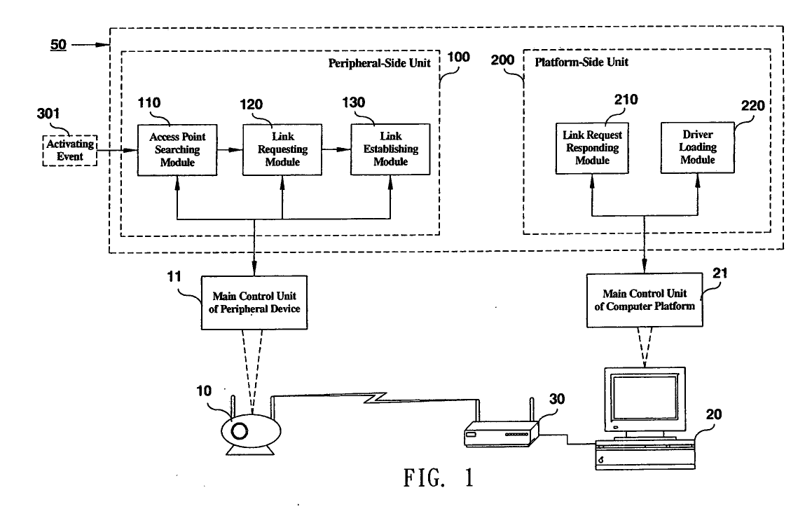

FIG. 1 is a schematic diagram showing the application and system architecture of the computer peripheral device wireless linking system according to the invention (as the part enclosed in the dotted box indicated by the reference numeral 50). As shown, the computer peripheral device wireless linking system of the invention 50 is based on a distributed architecture for integration to a wireless peripheral device 10 and a computer platform 20 linked to an access-point device 30, for the purpose of allowing the wireless peripheral device 10 to be wireless linkable via the access-point device 30 to the computer platform 20. In practical applications, for example, the computer platform 20 can be a desktop computer or a notebook computer, while the wireless peripheral device 10 can be a Web cam, a wireless sound recording device, a wireless video device, another computer platform such as a portable computer, to name just a few.

As shown in FIG. 1, the computer peripheral device wireless linking system of the invention 50 is based on a distributed architecture comprising 2 separate units: (A) a peripheral-side unit 100 for installation to the main control unit 11 of the wireless peripheral device 10; and (B) a platform-side unit 200 for installation to the main control unit 21 of the computer platform 20; and wherein the peripheral-side unit 100 includes: (A1) an access point searching module 110; (A2) a link requesting module 120; and (A3) a link establishing module 130; while the platform-side unit 200 includes: (B1) a link request responding module 210; and (B2) a driver loading module 220.

Firstly, the respective attributes and behaviors of the constituent modules 110, 120, 130 of the peripheral-side unit 100 installed on the wireless peripheral device 10 are described in details in the following.

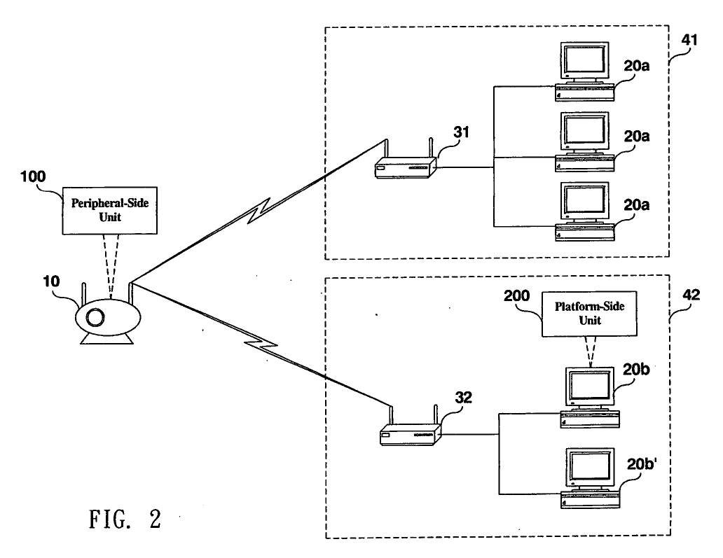

The access point searching module 110 is capable of responding to a user-initiated activating event 301 (such as an event of the user pressing the power button or a special function key on the wireless peripheral device 10) by using a conventional wireless LAN (Local Area Network) searching and linking method to search the nearby environment where the wireless peripheral device 10 is located for LAN access-point devices 30. If the access point searching module 110 finds at least one access-point device 30, it will issue a link requesting enable message to the link requesting module 120. If the access point searching module 110 finds two or more access-point devices, such as the two access-point device 31, 32 shown in FIG. 2, then it will build a listing of all the found access-point device 31, 32 and successively issue a link requesting enable message to the access-point device 31, 32 until a link is established.

The link requesting module 120 is capable of responding to the link requesting enable message from the access point searching module 110 by issuing a link requesting message and transferring the link requesting message by way of the main control unit 11 of the wireless peripheral device 10 and via each found access-point device 30 in the nearby environment to the associated computer platform 20.

The link establishing module 130 is capable of responding to a ready-for-linking message from the platform-side unit 200 installed on the computer platform 20 by establishing a wireless link between the wireless peripheral device 10 and the computer platform 20 via the access-point device 30, for the wireless peripheral device 10 and the computer platform 20 to be able to exchange data via the access-point device 30.

Subsequently, the respective attributes and behaviors of the constituent modules 210, 220 of the platform-side unit 200 installed on the computer platform 20 are described in details in the following.

The link request responding module 210 is capable of receiving the link requesting message via the access-point device 30 from the link requesting module 120, and respond to the received message by issuing a driver loading enable message to the driver loading module 220.

The driver loading module 220 is capable of responding to the driver loading enable message from the link request responding module 210 by performing a driver loading procedure to load a corresponding driver program of the wireless peripheral device 10 into the computer platform 20. After the driver loading procedure is completed, the driver loading module 220 is capable of issuing a ready-for-linking message via the access-point device 30 to the wireless peripheral device 10.

The following is a detailed description of a practical example of the application of the computer peripheral device wireless linking system of the invention 50 during actual operation. In this application example, as shown in FIG. 2, it is assumed that there are two wireless LAN systems 41, 42 installed in the nearby environment where the wireless peripheral device 10 is located. The first wireless LAN system 41 includes an access-point device 31 and a cluster of computer platforms 20a which are uninstalled with the platform-side unit 200 of the computer peripheral device wireless linking system of the invention 50. On the other hand, the second wireless LAN system 42 includes an access-point device 32 and a cluster of computer platforms 20b, 20b′, where only the computer platform 20b is installed with the platform-side unit 200 of the computer peripheral device wireless linking system of the invention 50, while the other computer platform 20b′ is uninstalled.

In actual operation, the user needs first to initiate an activating event 301 on the wireless peripheral device 10, for example by pressing the power button or a special function key (not shown) on the wireless peripheral device 10. This action causes the access point searching module 110 to respond by using a wireless LAN searching and linking method to search the nearby environment for any access-point devices within its radio range (i.e., the range where the radio signal from the wireless peripheral device 10 can reach).

In the example of FIG. 2, there exists two access-point devices 31, 32 near the wireless peripheral device 10. In this case, the access point searching module 110 will first build a listing of all the found access-point device 31, 32, and then issue a link requesting enable message to the link requesting module 120. In response, the link requesting module 120 issues a link requesting message by way of the main control unit 11 of the wireless peripheral device 10 to the first-found access-point device 31, and the link requesting message is subsequently transferred by the access-point device 31 to each of the linked computer platforms 20a. Since none of the computer platforms 20a is installed with the platform-side unit 200 of the computer peripheral device wireless linking system of the invention 50, no response will be received from any of these computer platforms 20a.

At the elapse of a predefined period after the link requesting module 120 receives no response from the access-point device 31, the link requesting module 120 will subsequently issue another link requesting message by way of the main control unit 11 of the wireless peripheral device 10 to the access-point device 32, and the link requesting message is subsequently transferred by the access-point device 31 to each of the linked computer platforms 20b, 20b′. Since the computer platforms 20b in the second wireless LAN system 42 is installed with the platform-side unit 200 of the computer peripheral device wireless linking system of the invention 50, the link request responding module 210 in the platform-side unit 200 will respond to the link requesting message by issuing a driver loading enable message to the driver loading module 220, thereby activating the driver loading module 220 to perform a driver loading procedure to load a corresponding driver program related to the wireless peripheral device 10 into the computer platform 20. After the driver loading procedure is completed, the driver loading module 220 issues a ready-for-linking message via the access-point device 30 back to the wireless peripheral device 10. In response to the ready-for-linking message from the computer platform 20b, the link requesting module 120 issues a link-establishing enable message to the link establishing module 130, activating the link establishing module 130 to establish a wireless link between the wireless peripheral device 10 and the computer platform 20 via the access-point device 30 for the wireless peripheral device 10 and the computer platform 20 to be able to exchange data via the access-point device 30. In the case of the wireless peripheral device 10 being a Web cam, the Web cam can then transfer the captured images via the access-point device 32 to the computer platform 20b.

In conclusion, the invention provides a computer peripheral device wireless linking method and system, which is characterized by the use of a wireless LAN searching and linking technology for a wireless peripheral device to be linked via a access-point device to a computer platform without having to use Ethernet ports, input devices, and monitor screens as in the case of prior art. This feature allows the wireless peripheral device to be linked to the computer platform with an instant play capability, such that the use of the wireless peripheral device is more convenient. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for linking a wireless peripheral device via an access-point device to a computer platform, which comprises:
on the wireless peripheral device, performing an access-point device searching procedure to search the nearby environment where the wireless peripheral device is located for any access-point devices; and if at least one is found, issuing a link requesting enable message;
on the wireless peripheral device, responding to the link requesting enable message by issuing a link requesting message to the access-point device which then transfers the link requesting message to the computer platform;
on the computer platform, responding to the link requesting message by issuing a driver loading enable message;
on the computer platform, responding to the driver loading enable message by performing a driver loading procedure to load a corresponding driver program related to the wireless peripheral device into the computer platform; and after the driver loading procedure is completed, issuing a ready-for-linking message via the access-point device to the wireless peripheral device; and
on the wireless peripheral device, responding to the ready-for-linking message by establishing a wireless link between the wireless peripheral device and the computer platform via the access-point device.

2. The method as recited in claim 1, wherein the wireless peripheral device is a Web cam.

3. The method as recited in claim 1, wherein the wireless peripheral device is a wireless sound recording device.

4. The method as recited in claim 1, wherein the wireless peripheral device is a wireless video device.

5. The method as recited in claim 1, wherein the wireless peripheral device is a portable computer.

6. The method as recited in claim 1, wherein if the access-point device searching procedure finds at least two access-point devices, building a listing of all the found access-point device on the wireless peripheral device and successively issue a link requesting enable message to these access-point devices until a link is established

7. A system for linking a wireless peripheral device via an access-point device to a computer platform, which comprises:
a peripheral-side unit, which is installed on the wireless peripheral device, and which includes an access point searching module, a link requesting module, and a link establishing module; and
a platform-side unit, which is installed on the computer platform, and which includes a link request responding module and a driver loading module; wherein
the access point searching module in the peripheral-side unit is capable of searching the nearby environment where the wireless peripheral device is located for any access-point devices; if at least one is found, capable of issuing a link requesting enable message;
the link requesting module in the peripheral-side unit is capable of responding to the link requesting enable message from the access point searching module by issuing a link requesting message to the access-point device;
the link request responding module in the platform-side unit is capable of responding to the link requesting message from the link requesting module in the peripheral-side unit by issuing a driver loading enable message;
the driver loading module in the platform-side unit is capable of responding to the driver loading enable message from the link request responding module by performing a driver loading procedure to load a corresponding driver program related to the wireless peripheral device into the computer platform; and after the driver loading procedure is completed, capable of issuing a ready-for-linking message via the access-point device to the wireless peripheral device; and
the link establishing module in the peripheral-side unit is capable of responding to the ready-for-linking message from the driver loading module in the platform-side unit by establishing a wireless link between the wireless peripheral device and the computer platform via the access-point device.

8. The system as recited in claim 7, wherein the wireless peripheral device is a Web cam.

9. The system as recited in claim 7, wherein the wireless peripheral device is a wireless sound recording device.

10. The system as recited in claim 7, wherein the wireless peripheral device is a wireless video device.

11. The system as recited in claim 7, wherein the wireless peripheral device is a portable computer.

12. The system as recited in claim 7, wherein if the access point searching module finds at least two access-point devices, the access point searching module is capable of building a listing of all the found access-point device and successively issue a link requesting enable message to these access-point devices until a link is established.
